(19) United States
(12) Patent Application Publication
(10) Pub. No.: US 2026/0023786 A1
(43) Pub. Date: Jan. 22, 2026

(54) SYSTEMS AND METHODS FOR A KNOWLEDGE GRAPH BASED ARTIFICIAL INTELLIGENCE CONVERSATION AGENT

(71) Applicant: Salesforce, Inc., San Francisco, CA (US)

(72) Inventors: Prafulla Kumar Choubey, San Jose, CA (US); Xiangyu (Becky) Peng, Palo Alto, CA (US); Caiming Xiong, Menlo Park, CA (US); Lik (Phil) Mui, San Francisco, CA (US); Ricky Ho, San Francisco, CA (US); Chien-Sheng (Jason) Wu, Mountain View, CA (US)

(21) Appl. No.: 19/006,731

(22) Filed: Dec. 31, 2024

Related U.S. Application Data
(60) Provisional application No. 63/673,105, filed on Jul. 18, 2024.

(51) Int. Cl. G06F 16/9032; G06F 16/9038; G06N 3/042; G06N 3/0475; G06N 3/09

(52) U.S. Cl. CPC G06F 16/90332; G06F 16/9038; G06N 3/042; G06N 3/0475; G06N 3/09

(57) ABSTRACT

Embodiments described herein provide knowledge graph synthesis pipeline to generate a knowledge graph from long documents so as to serve a retrieval augmented generation (RAG) large language model (LLM) based AI chat agent. Specifically, each document is decontextualized by substituting entity references with their explicit mentions. Subsequently, to enhance coverage, the document is segmented into chunks and entities and relations are extracted from each chunk independently, e.g., by an LLM. The extracted entities and relations are then synthesized into a knowledge graph for the document. Therefore, the retrieval component may search the knowledge graph based on a received user query to retrieve entities and relations, which are in turn input to an LLM to generate a response.

### CROSS REFERENCE

This instant application is a nonprovisional of and claims priority under 35 U.S.C. 119 to U.S. provisional application No. 63/673,105, filed Jul. 18, 2024, which is hereby expressly incorporated herein by reference in its entirety.

### TECHNICAL FIELD

The embodiments relate generally to machine learning systems for an artificial intelligent (AI) conversation agent, and more specifically to systems and methods for a knowledge graph based artificial intelligence conversation agent.

### BACKGROUND

AI conversation agents, commonly known as chatbots or virtual assistants, can be applied to a wide range of practical applications across various industries. In customer service, AI agents can handle user inquiries, provide support, and resolve issues 24/7, improving customer satisfaction and reducing operational costs. In healthcare, AI agents can offer initial consultations, answer health-related questions, and remind patients to take their medications. In the e-commerce sector, AI conversation agents can assist with product recommendations, order tracking, and personalized shopping experiences. In information technology (IT) support, these agents can guide users through troubleshooting steps, helping them resolve software and hardware issues. Specifically, for network hazards, AI conversation agents can diagnose connectivity problems, suggest corrective actions, and provide step-by-step guidance to ensure network security and stability. Their versatility and ability to handle diverse tasks make them valuable tools in enhancing efficiency and user experience in various fields.

Such AI agents, for example, may adopt a neural network model, such as a large language model (LLM), which receives a user input text and in turn generates a response that is to e communicated to a user via a visualized user interface, or an audio interface. To distill knowledge in order to generate the response, contextual information, such as documents, may be input to the LLM such that the response may be generated conditioned on the context of such contextual documents. However, when the contextual document is lengthy, distilling relevant information from such long documents for generating a response to a user input query remains challenging.

### BRIEF DESCRIPTION OF THE DRAWINGS

FIG. 1 shows an application of an LLM based AI conversation agent, according to embodiments of the present disclosure.

FIG. 2 is a simplified diagram illustrating aspects of a framework for generating and/or synthesizing a knowledge graph for finetuning LLM(s), according to embodiments described herein.

FIG. 3 is a simplified diagram illustrating aspects of a graph retriever for multi-hop reasoning at an inference of LLM(s), according to embodiments described herein.

FIG. 4 is a simplified diagram illustrating a computing device implementing the AI chat agent, according to one embodiment described herein.

FIG. 5 is a simplified diagram illustrating the neural network structure implementing the AI chat agent module described in FIG. 4, according to some embodiments.

FIG. 6 is a simplified block diagram of a networked system suitable for implementing the retrieval augmented generation LLM framework described in FIGS. 1-5 and other embodiments described herein.

FIG. 7 is an example logic flow diagram illustrating a method of building an artificial intelligence (AI) conversation agent using a knowledge graph based on the framework shown in FIGS. 1-6, according to some embodiments described herein.

FIG. 8 is an example logic flow diagram illustrating a method of constructing a proposition-entity knowledge graph in FIG. 7, according to some embodiments described herein.

FIGS. 9-11 provide example performance charts of a knowledge graph based LLM described in FIGS. 1-8, according to embodiments described herein.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters. An LLM may comprise an architecture of mixed software and/or hardware, e.g., including an application-specific integrated circuit (ASIC) such as a Tensor Processing Unit (TPU).

As used herein, the term “generative artificial intelligence (AI)” may refer to an AI system that outputs new content that does not pr-exist in the input to such AI system. The new content may include text, images, music, or code. An LLM is an example generative AI model that generate tokens representing new words, sentences, paragraphs, passages, and/or the like that do not pre-exist in an input of tokens to such LLM. For example, when an LLM generate a text answer to an input question, the text answer contains words and/or sentences that are literally different from those in the input question, and/or carry different semantic meaning from the input question.

Retrieval augmented generation (RAG) LLM may comprise a retrieval component that searches a large database of documents to find the most relevant pieces of information based on an input query and a generative LLM that contextually relevant text based on the input query and the retrieved information. For example, the retrieval component may comprise a search engine or a specialized retrieval model. The retrieved documents or snippets may serve as a source of information for the generative LLM. In this way, by grounding the generation in real-world documents, RAG LLMs can produce more factually accurate and relevant responses. Also, as the retrieval component can access up-to-date information, RAG LLMs are often able to generate texts on topics that evolve over time, without constant re-training or finetuning.

In some embodiments, documents may be converted to a structured representation of information, typically in the form of nodes (entities) and edges (relationships between entities), referred to as knowledge graph. Therefore, instead of searching through unstructured text documents, the retrieval component queries the knowledge graph to find relevant entities and relationships based on the input query, and therefore retrieve relevant information from the knowledge graph efficiently. On the other hand, with the detailed and interconnected nature of knowledge graphs, the generative model can produce responses that are more accurate and contextually rich.

Constructing a knowledge graph typically includes two stages: 1) extracting all nodes (e.g., entities or concepts) present in documents, and 2) identifying all relationships between related nodes based on context. This extraction process, however, involves a critical trade-off between nodes and relationships coverage versus their quality. Particularly, for long documents, low node and edge coverage may lead to undesirable performance of the generative LLM, but increasing node and edge coverage significantly increase computational and thus hardware overhead of the AI chat agent.

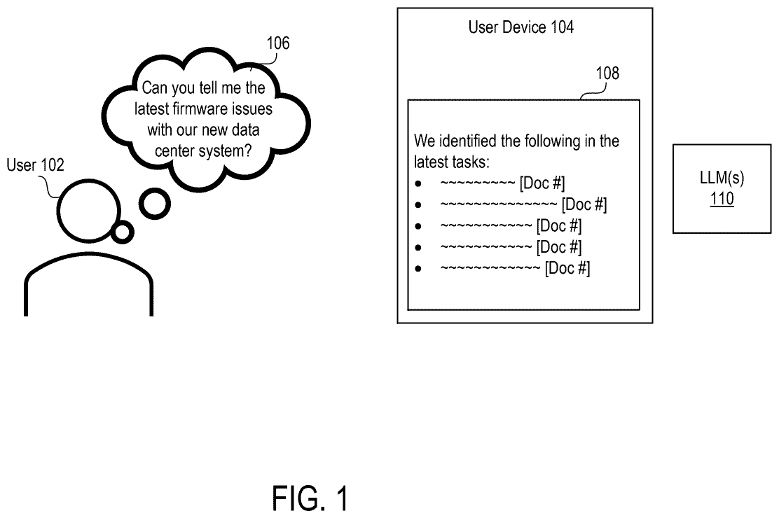

Embodiments described herein provide knowledge graph synthesis pipeline to generate a knowledge graph from long documents so as to serve a RAG LLM based AI chat agent. Specifically, each document is decontextualized by substituting entity references with their explicit mentions (e.g., replacing OWCP with OWC Pharmaceutical Research Corp in FIG. 1). Subsequently, to enhance coverage, the document is segmented into chunks and entities and relations are extracted from each chunk independently, e.g., by an LLM. The extracted entities and relations are then synthesized into a knowledge graph for the document. Therefore, the retrieval component may search the knowledge graph based on a received user query to retrieve entities and relations, which are in turn input to an LLM to generate a response.

In one embodiment, an LLM (e.g., a smaller LLM compared to the RAG LLM) may be finetuned to extract three types of structured information from a document: 1. entities, 2. triplets, and 3. quadruplets.

In this way, the enhanced knowledge graph may improve accuracy and efficiency of response generation of the AI chat agent. Therefore, AI-assisted technology in a wide variety of applications such as medical diagnostics, IT issue spotting, network management, autonomous driving, and/or the like may be improved.

FIG. 1 shows an application 100 of an LLM based AI conversation agent, according to embodiments of the present disclosure. A user 102 may utter a query 106 in natural language. In response, a user device 104 may output/display an answer 108 on a display interface, such as a screen. In some embodiments, answer 108 is the output of an artificial intelligence (AI) chatbot, which is built on a bot server that is communicatively connected to user device 104. The chatbot may be based on, or include, one or more LLMs 110. In some embodiments, the LLM(s) may receive query 106 through utterance of user 102, which may retrieve a corpus of documents, and generate an output based on the retrieved documents.

As an example, query 106 may include a question of “can you tell me the latest firmware issues with our new data center system?” The AI conversation agent may include the query 106 in a predefined format providing instruction to the LLM 110 how to generate a response to query 106, referred to as a “prompt,” which may be fed to an LLM 110 as input. The LLM 110 may in turn provide answer 108, e.g., a summary of firmware issues in a pre-defined format, e.g., a bullet-point format, etc. In some aspects, for example, a citation of document(s) that mention the task issue is provided behind the respective bullet.

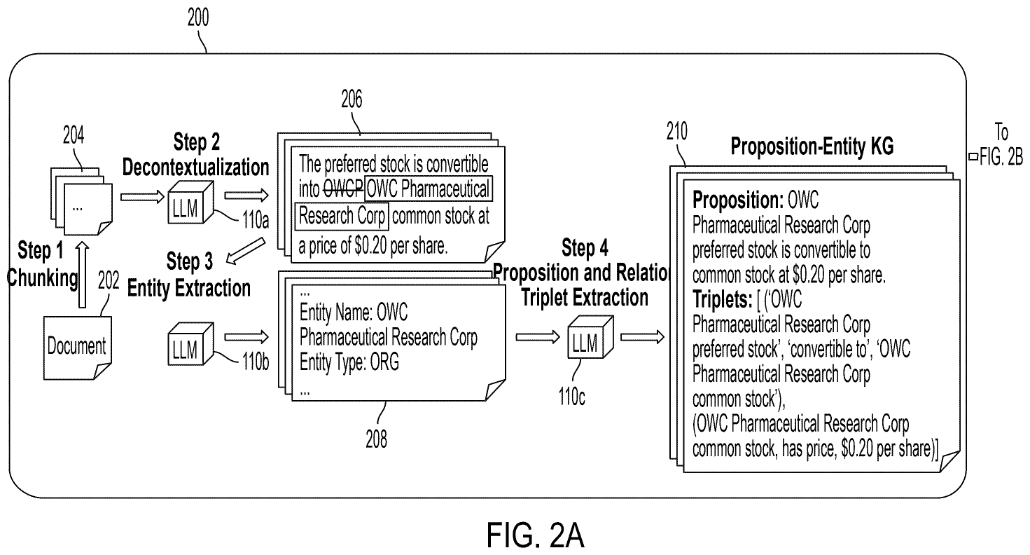

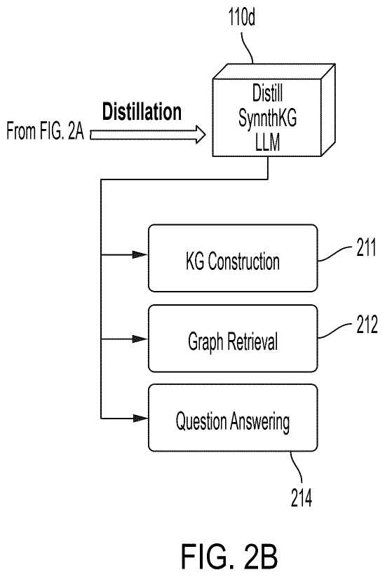

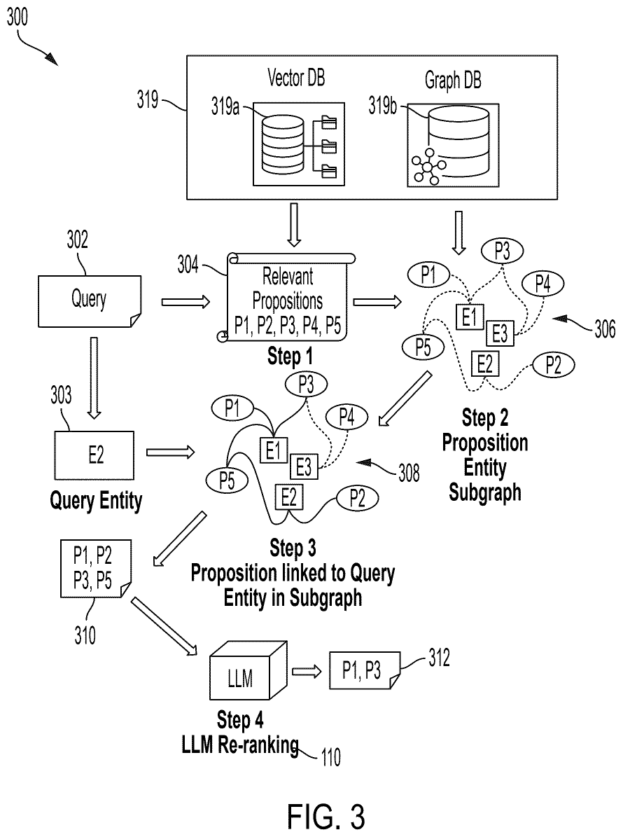

The underlying LLM 110 may be implemented at user device 102, or at a remote server which is accessible by the user device 102. The LLM 110 may be trained with a large corpus of texts and/or documents which are generated into a knowledge graph as further described in FIGS. 2-3.

FIG. 2 is a simplified diagram illustrating aspects of a framework for generating and/or synthesizing a knowledge graph for finetuning LLM(s) 110, according to embodiments described herein. As shown in FIG. 2, a knowledge graph synthesis pipeline 220 may generate knowledge graphs from documents using LLMs 110a-110d. For example, knowledge graphs may be generated from documents 202 using a larger LLM 110a-c, such as GPT-4o, Llama-3.1-70B-Instruct. The generated knowledge graphs together with documents 202 may form document-graph pairs to train a smaller LLM 110d (such as Meta-Llama-3-8B-Instruct model) to generate a knowledge graph based on an input document. In this way, the smaller LLM 110d may then be used to generate knowledge graphs with accuracy and efficiency.

In one embodiment, the knowledge graph synthesis pipeline 200 performs document chunking and decontextualization, followed by entity, relation and proposition extraction to provide high coverage of extracted entities and relations while minimizing information loss in the resulting knowledge graph for a document. For example, given a document 202 in a database for RAG, the document 202 may be split into a plurality of segments (referred to as “chunks”) 204. This chunking process may be done along sentence boundaries, without overlap, to preserve semantic coherence and avoid redundancy.

In some implementations, processing each chunk 204 in isolation may lead to a loss of prior context, because an isolated chunk may often contain entities that are not informatively defined in the respective chunk, but may have been informatively defined in a prior chunk. For example, if “John Doe” appears in one chunk and “John” in a later chunk, the two mentions of “John Doe” and “John” are to be related to the same entity. Therefore, a decontextualization step may be performed on the plurality of chunks 204 to consistently rewrite all mentions of entities in each chunk 204 into an informative form. For example, an LLM 110a may receive an input prompt comprising an instruction for LLM 110a to rewrite each chunk, replacing all entity mentions with their most informative form based on the context of the preceding chunk—e.g., if “John Doe” is introduced in a previous chunk, subsequent mentions of “John D.” “John,” or related pronouns are replaced with “John Doe.”

An example prompt for decontextualization may take a form similar to the following:

Previous paragraph from Document:
Gualala, the isolated Mendocino Coast town with a name that leaves most visitors tongue-tied, is on a new list of the 50 best places to live in the United States. Men's Journal magazine describes Gualala as an outpost of adventure lifestyle ïn its latest edition, which goes on sale today. The magazine describes Gualala (pronounced wa-LA-la by locals) as one of the “below-the-radar places to a make a move on before the word gets out. “There were five such cities. The others were Homer, Alaska; Newport, Vt.; Logan, Utah; and Walla Walla, Wash. Rolling Stone magazine's Jann Wenner publishes Men's Journal, which has a paid circulation of about 620,000. Gualala joined three other California communities on the magazine's list: Santa Cruz, Mammoth Lakes and Bishop. “We were looking for places that combined affordability, proximity to outdoor adventure and a generally undiscovered quality of life,” said Erica Kestenbaum, a spokeswoman for Men's Journal.

### Instruction:

Rewrite the below paragraph by resolving all entity coreferences with the preceding paragraph from document.
Resolve all inter-sentence pronoun references.
Make sure that all pronouns in a sentence refers to some named entity with in the same sentence.
Explicitly mention entity names wherever necessary to remove ambiguity from a sentence. Remember to make each sentence clear and unambiguous.

For each entity, use only the one most informative name.
Do not generate anything except the rewritten paragraph.

### Paragraph:

She said isolation played a factor. “In Northern California, it's particularly difficult to find a beautiful coastal setting that isn't entirely overrun,” she said. Gualala residents Monday were largely unaware of the magazine listing or the attention it could bring to the old logging town turned tourist center. A few coastal residents chuckled about any notion of affordability, given an influx of newcomers who've driven the median housing price to $580,000 compared to the median family income of $47,778. Others recalled an era when the Gualala region was better known for the logging of ancient redwoods, marijuana growing and boisterous beer drinking at the historic Gualala Hotel. Still there was a certain pride to the magazine's designation. Yvette White, a 25-year resident who works at the Gualala Sport; Tackle shop, said she's proud her town made it on the list.

### Output:

Erica Kestenbaum said isolation played a factor. In Northern California, it's particularly difficult to find a beautiful coastal setting that isn't entirely overrun, Erica Kestenbaum said. Gualala residents Monday were largely unaware of the Men's Journal magazine listing or the attention it could bring to the old logging town turned tourist center. A few coastal residents of Gualala chuckled about any notion of affordability, given an influx of newcomers who've driven the Gualala's median housing price to $580,000 compared to the median family income of $47,778. Other Gualala residents recalled an era when the Gualala region was better known for the logging of ancient redwoods, marijuana growing and boisterous beer drinking at the historic Gualala Hotel. Still there was a certain pride to the Men's Journal magazine's designation. Yvette White, a 25-year Gualala resident who works at the Gualala Sport; Tackle shop, said she's proud her town made it on the list.

Previous paragraph from Document: [previous paragraph]

### Instruction:

Rewrite the below paragraph by resolving all entity coreferences with the preceding paragraph from document.
Resolve all inter-sentence pronoun references.
Make sure that all pronouns in a sentence refers to some named entity with in the same sentence.
Explicitly mention entity names wherever necessary to remove ambiguity from a sentence. Remember to make each sentence clear and unambiguous.
For each entity, use only the one most informative name.
Do not generate anything except the rewritten paragraph.
   Paragraph: [paragraph]

### Output:

In this way, the resulting decontextualized chunks 206 preserves context of the document 202, and also prevents the same entity from being represented in different forms, thus preventing redundancy or discontinuous knowledge graph paths during inference or retrieval.

In one embodiment, an extraction prompt comprising an instruction to extract entities from a chunk 206 may be provided to LLM 110b to extract all entities and their corresponding types 208 from each text chunk 206. The LLM 110c may then generate all propositions and corresponding relation triplet based on the text chunk 206 and previously extracted entities. For example, each relation is represented by quadruplets 210 consisting of a source entity, predicate, target entity, and a proposition. The proposition is a sentence that describes the semantic relation between the source and target entities, encapsulating all key details of that relation.

An example prompt for entity (graph node) extraction may take a form similar to the following:

Extract all named entities from the document. Also generate the type for each entity.

### Instructions:

Generate only the most informative name for each named entity. Example: if John P., Parker, John Parker are coreferential, only generate John Parker.

Use your best understanding best on the domain of paragraph to decide appropriate entity types.

Respond using json format provided below.

{“n1”: {“name”: “entity_name”, “type”: “entity_type_label”}, “n2”: {},}
Below is an example for reference.
Paragraph: Tucked into Eli Lilly's year-end earnings report, the company revealed positive results from Synergy-NASH—its phase 2 study of tirzepatide in adults in nonalcoholic steatohepatitis (NASH), also known as metabolic dysfunction-associated steatohepatitis (MASH).

### Output:

{“n1”: {“name”: “Eli Lilly”, “type”: “Organization”},
“n2”: {“name”: “Synergy-NASH”, “type”: “Clinical Trial”},
“n4”: {“name”: “tirzepatide”, “type”: “Drug”},
“n5”: {“name”: “nonalcoholic steatohepatitis”, “type”: “Disease”},
“n6”: {“name”: “metabolic dysfunction-associated steatohepatitis”, “type”: “Disease”}, “n7”: {“name”: “year-end earnings report”, “type”: “Document”}}

An example prompt for extracting relations may take a form similar to the following:

Extract all facts from the document. For each fact, also generate all semantic triplets.

### Instructions

Consistently use the most informative name for each named entity in all facts and triplets.
Avoid pronouns or ambiguous references in facts and triplets. Instead, directly include all relevant named entities in facts.
Ensure that each semantic triplet contains head entity, predicate, and tail entity.
Ensure that at least one (preferably both) entity in each semantic triplet is present in the given entities list.

Respond using json format provided below:

{“f1”: {“fact”: “A factual statement describing important information (preferably about some entities) from the paragraph”, “triplets: [[“entity 1”, “predicate”, “entity 2”], [“entity 1”, “predicate”, “entity 3”]]}
“f2”:{},}
Below is an example for reference.
Paragraph: Locked in a heated battle with Novo Nordisk's semaglutide franchise, Eli Lilly's tirzepatide is beginning to come into its own—both with regards to sales and amid attempts to show the dual GIP/GLP-1 agonist can strike out beyond diabetes and obesity. As Mounjaro, tirzepatide won its first FDA nod in Type 2 diabetes back in May 2022. An obesity approval followed last November, with that formulation of tirzepatide adopting the commercial moniker Zepbound. In 2023′s fourth quarter, Mounjaro generated a whopping $2.2 billion in sales, a nearly eight-fold increase over the $279 million it pulled down during the same stretch in 2022. Year-to-date, the drug brought home around $5.2 billion in revenues, Lilly said in an earnings release Tuesday. Zepbound, for its part, generated $175.8 million during its first quarter on the market. Overall, Lilly reeled in around $9.4 billion in fourth-quarter sales, growing 28% over the $7.3 billion it made for the quarter in 2022.

### Entities: Eli Lilly, Novo Nordisk, Tirzepatide, Semaglutide, GLP-1, GIP, FDA, Mounjaro, Zepbound

### Output:

“f1”: {“fact”: “Eli Lilly's tirzepatide is competing with Novo Nordisk's semaglutide franchise.”,

“triplets”: [[“Eli Lilly”, “competing with”, “Novo Nordisk”], [“Tirzepatide”, “is competing with”, “Semaglutide”]]}
“f2”: {“fact”: “Eli Lilly is trying to show tirzepatide, the dual GIP/GLP-1 agonist, can strike out beyond diabetes and obesity.”, “triplets”: [[“Eli Lilly”, “is trying to show”, “Tirzepatide”], [“Tirzepatide”, “is a”, “dual GIP/GLP-1 agonist”], [“Tirzepatide”, “can treat beyond”, “Diabetes”], [“Tirzepatide”, “can treat beyond”, “Obesity”]]}
“f2”: {“fact”: “Tirzepatide, under the brand name Mounjaro, received its first FDA approval for Type 2 diabetes in May 2022.”, “triplets”: [[“Tirzepatide”, “branded as”, “Mounjaro”], [“Mounjaro”, “won”, “FDA approval”], [“FDA approval”, “for”, “Type 2 diabetes”], [“FDA approval”, “was in”, “May 2022”]]}
“f4”: {“fact”: “Tirzepatide, under the brand name Zepbound, received an obesity approval in November 2022. ”,
“triplets”: [[“Tirzepatide”, “was branded as”, “Zepbound”], [“Zepbound”, “received”, “Obesity approval”], [“Obesity approval”, “was in”, “November 2022”]]}
“f5”: {“fact”: “Mounjaro generated $2.2 billion in sales in the fourth quarter of 2023, an eight-fold increase from the $279 million during the same period in 2022.”,
“triplets”: [[“Mounjaro”, “2023′s fourth quarter sales”, “$2.2 billion sales”], [“Mounjaro”, “2022's fourth quarter sales”, “$279 million”]]},
“f6”: {“fact”: “Mounjaro brought in around $5.2 billion in revenues year-to-date in 2023, Lilly said in an earnings release Tuesday”, “triplets”: [[“Mounjaro”, “2023 sales year-to-date”, “$5.2 billion revenues”]]}
“f7”: {“fact”: “Zepbound generated $175.8 million in sales in its first quarter on the market.”, “triplets”: [[“Zepbound”, “first quarter sales”, “$175.8 million”]]} “f8”:
“f8”: {“fact”: “Eli Lilly's fourth-quarter sales were around $9.4 billion, a 28% increase over the $7.3 billion during the same period in 2022.”, “triplets”: [[“Eli Lilly”, “2023 fourth-quarter sales”, “$9.4 billion,”], [“Eli Lilly”, “2022 fourth-quarter sales”, “$7.3 billion,”]]}}

In this way, by adding a proposition component in constructing a knowledge graph for a document, an LLM may first articulate the relevant context coherently before extracting the corresponding triplets. In addition, the proposition may act as a fine-grained, self-contained retrieval unit, which facilitates the construction of knowledge graph-based retrieval indices. For example, as shown in FIG. 2, the proposition “OWC Pharmaceutical Research Corp preferred stock is convertible to common stock at $0.20 per share.” provides important contextual details, such as the “conversion price $0.20 per share,” and also serves as a precise, indexable unit.

In at least one embodiment, a knowledge graph may be constructed using the generated proposition-entities 210 from document 202. For example, the knowledge graph may comprise nodes representing the source entity and the target entity, and an edge connecting the nodes representing the predicate information and the proposition. Such proposition-entity knowledge graph may be constructed and stored for each document.

In one embodiment, instead of using LLMs 110a-110c to construct the proposition-entity knowledge graph for each document 202 in a document database, a relatively smaller LLM 110d may be trained using the document-knowledge graph pairs to directly generate a knowledge graph for an input document. For example, the knowledge graph synthesis pipeline 200 may construct a knowledge graph for each document in a database, which entails repeatedly prompting an LLM 110a-110c. When LLM 110a-110c are housed at an external server, substantial computational or application programming interface (API) costs may be incurred. For example, processing a 1000-word document can involve 12 LLM inference calls (4 chunks, with 3 calls per chunk for decontextualization, entity extraction, and relation extraction). To improve computational efficiency, a smaller LLM 110d may be trained by the document 202 and the proposition-entity knowledge graph 210 pair. Specifically, a smaller LLM 110d (e.g., fewer number of layers, fewer number of parameters, or otherwise requiring less computational resource, etc.) may be finetuned to take an entire document 202 as input, to directly generate a predicted knowledge graph to be compared with the ground-truth knowledge graph 210. In this way, the smaller LLM 110d may be trained to generate a knowledge graph (e.g., 211) in a single inference step.

In some embodiments, the smaller LLM 110d may be trained by the document 202 and the proposition-entity knowledge graph 210 pair for knowledge graph construction 211, a graph retrieval 212, question answering 214 (based on the knowledge graph), and/or the like. For example, to finetune the smaller LLM 110d for graph retrieval 212 and/or question answering 214 (based on a retrieved graph), the smaller LLM 110d may act as a proposition-entity graph retriever as described in FIG. 3 below.

FIG. 3 is a simplified diagram illustrating aspects of a graph retriever for multi-hop reasoning at an inference of LLM(s) 110, according to embodiments described herein. In one embodiment, a user query 302 may require multi-hop reasoning. For example, a question 302, such as “the birthplace of George McCall Theal is a port city of what bay” requires multi-hops of reasoning.

In one embodiment, the top-M most relevant propositions 304 may be retrieved, from a vector database 319a storing encoded vector representations of documents, and/or from a knowledge graph database 319b storing proposition-entity knowledge graphs of documents generated by the synthesis pipeline 200 described in FIG. 2. In one embodiment, the retrieval may be performed by using embedding similarity between the vector, and the embeddings of the query 302, and/or the similarity between the graph embedding and the embeddings of the query 302. In this way, the search space may be narrowed to a smaller subset of relevant information.

In one embodiment, a sub-graph 306 consisting of these propositions 304 and their linked entities may be constructed. This sub-graph 306 capture the relations among the retrieved propositions 306.

In one embodiment, the sub-graph 306 may be traversed, starting from the entities mentioned in the question 302, and only propositions (e.g., 310) within their N-hop neighborhood from the entities mentioned in the question 302 will be selected. In this way, this process filters out semantically similar but irrelevant propositions. The selected propositions 310 are only those logically connected to the question entities.

In one embodiment, an LLM 110 may re-rank text chunks corresponding to the selected propositions 310 based on their embedding similarity to the query. Then a selective top-K chunks are selected from the re-ranked chunks, as retrieved text chunks for answering the question 302.

In one embodiment, an LLM 110 may identify the necessary propositions 312 to answer the question 302 from those retrieved chunks. The LLM 110 may re-rank the selected propositions 312. Following this LLM-based re-ranking, the chunks corresponding to the LLM-identified propositions may be used as context for answer generation first, and then fall back to the retrieving process 300 to select additional chunks until the top-K chunks are selected.

### Computer and Network Environment

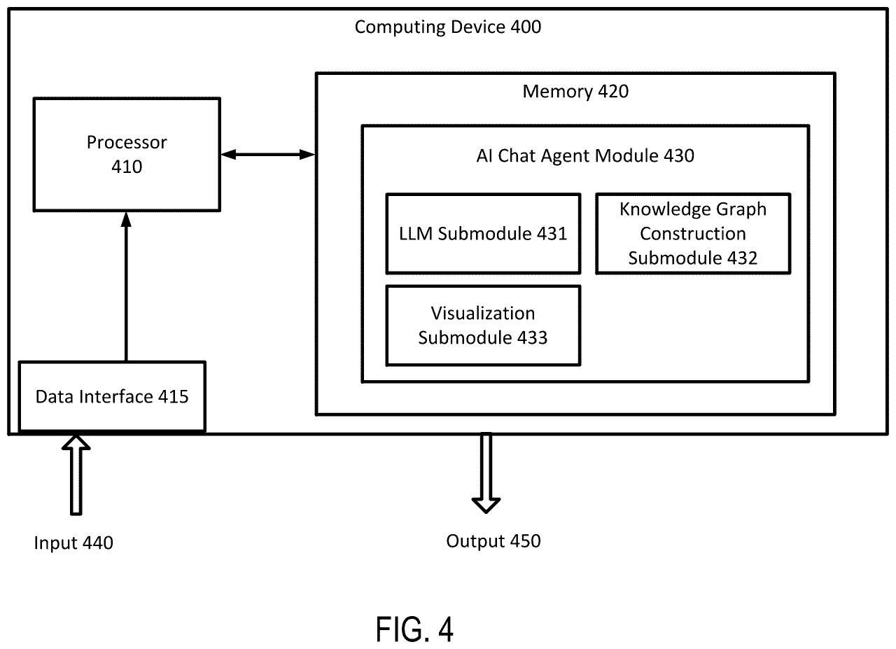

FIG. 4 is a simplified diagram illustrating a computing device implementing the AI chat agent, according to one embodiment described herein. As shown in FIG. 4, computing device 400 includes a processor 410 coupled to memory 420. Operation of computing device 400 is controlled by processor 410. And although computing device 400 is shown with only one processor 410, it is understood that processor 410 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 400. Computing device 400 may be implemented as a stand-alone subsystem, as a board added to a computing device, and/or as a virtual machine.

Memory 420 may be used to store software executed by computing device 400 and/or one or more data structures used during operation of computing device 400. Memory 420 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 410 and/or memory 420 may be arranged in any suitable physical arrangement. In some embodiments, processor 410 and/or memory 420 may be implemented on a same board, in a same package (e.g., system-in-package), on a same chip (e.g., system-on-chip), and/or the like. In some embodiments, processor 410 and/or memory 420 may include distributed, virtualized, and/or containerized computing resources. Consistent with such embodiments, processor 410 and/or memory 420 may be located in one or more data centers and/or cloud computing facilities.

In some examples, memory 420 may include non-transitory, tangible, machine readable media that includes executable code that when run by one or more processors (e.g., processor 410) may cause the one or more processors to perform the methods described in further detail herein. For example, as shown, memory 420 includes instructions for AI chat agent module 430 that may be used to implement and/or emulate the systems and models, and/or to implement any of the methods described further herein. AI chat agent module 430 may receive input 440 such as an input training data (e.g., such as a user query) via the data interface 415 and generate an output 450 which may be a response to the user query.

The data interface 415 may comprise a communication interface, a user interface (such as a voice input interface, a graphical user interface, and/or the like). For example, the computing device 400 may receive the input 440 (such as a training dataset) from a networked database via a communication interface. Or the computing device 400 may receive the input 440, such as a user query, from a user via the user interface.

In some embodiments, the AI chat agent module 430 is configured to generate a response to a user query for a plurality of tasks, such as IT support, customer service, virtual learning, machine translation, and/or the like. The AI chat agent module 430 may further include LLM submodule 431, knowledge graph construction submodule 432, visualization submodule 433, and/or the like.

Some examples of computing devices, such as computing device 400 may include non-transitory, tangible, machine readable media that include executable code that when run by one or more processors (e.g., processor 410) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

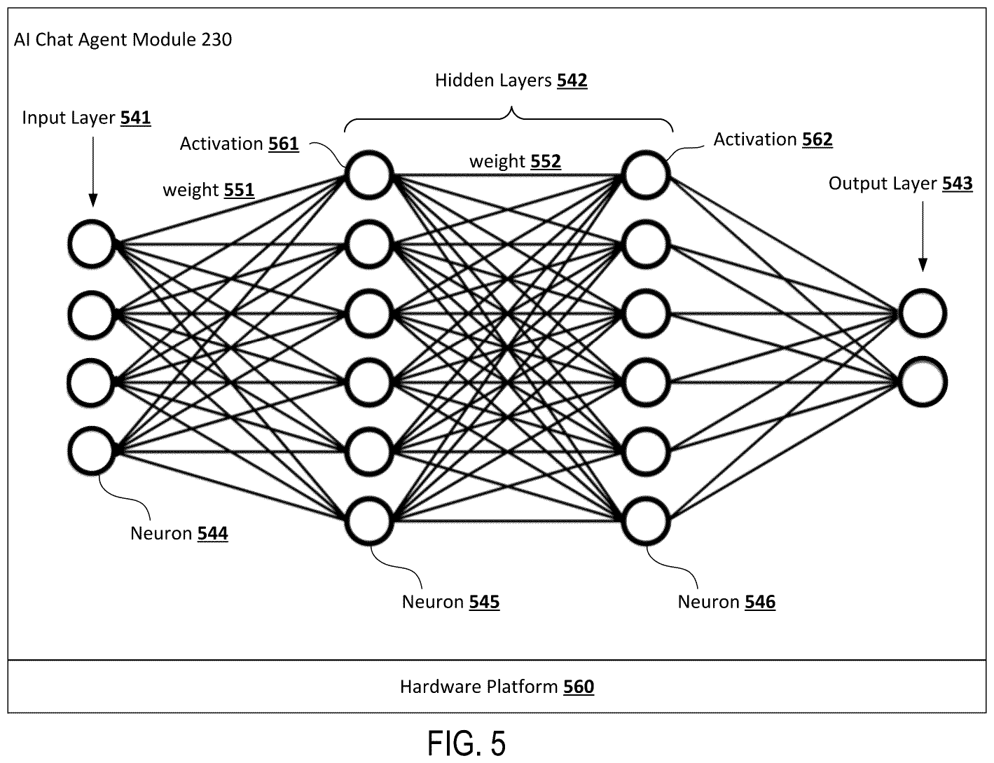

FIG. 5 is a simplified diagram illustrating the neural network structure implementing the AI chat agent module 430 described in FIG. 4, according to some embodiments. In some embodiments, the AI chat agent module 430 and/or one or more of its submodules 431-433 may be implemented at least partially via an artificial neural network structure shown in FIG. 5. The neural network comprises a computing system that is built on a collection of connected units or nodes, referred to as neurons (e.g., 544, 545, 546). Neurons are often connected by edges, and an adjustable weight (e.g., 551, 552) is often associated with the edge. The neurons are often aggregated into layers such that different layers may perform different transformations on the respective input and output transformed input data onto the next layer.

For example, the neural network architecture may comprise an input layer 541, one or more hidden layers 542 and an output layer 543. Each layer may comprise a plurality of neurons, and neurons between layers are interconnected according to a specific topology of the neural network topology. The input layer 541 receives the input data (e.g., 540 in FIG. 5), such as a user input, or a document. The number of nodes (neurons) in the input layer 541 may be determined by the dimensionality of the input data (e.g., the length of a vector of a text snippet. Each node in the input layer represents a feature or attribute of the input.

The hidden layers 542 are intermediate layers between the input and output layers of a neural network. It is noted that two hidden layers 542 are shown in FIG. 5B for illustrative purpose only, and any number of hidden layers may be utilized in a neural network structure. Hidden layers 542 may extract and transform the input data through a series of weighted computations and activation functions.

For example, as discussed in FIG. 5, the AI chat agent module 230 receives an input 540 of a document and transforms the input into an output 550 of a text response. To perform the transformation, each neuron receives input signals, performs a weighted sum of the inputs according to weights assigned to each connection (e.g., 551, 552), and then applies an activation function (e.g., 561, 562, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 541 is transformed into rather different values indicative data characteristics corresponding to a task that the neural network structure has been designed to perform.

The output layer 543 is the final layer of the neural network structure. It produces the network's output or prediction based on the computations performed in the preceding layers (e.g., 541, 542). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the AI chat agent module 230 and/or one or more of its submodules 231-233 may comprise the transformative neural network structure of layers of neurons, and weights and activation functions describing the non-linear transformation at each neuron. Such a neural network structure is often implemented on one or more hardware processors 510, such as a graphics processing unit (GPU). An example neural network may be GPT-4, and/or the like.

In one embodiment, the AI chat agent module 430 and its submodules 431-433 may comprise one or more LLMs built upon a Transformer architecture. For example, the Transformer architecture comprises multiple layers, each consisting of self-attention and feedforward neural networks. The self-attention layer transforms a set of input tokens (such as words) into different weights assigned to each token, capturing dependencies and relationships among tokens. The feedforward layers then transform the input tokens, based on the attention weights, represents a high-dimensional embedding of the tokens, capturing various linguistic features and relationships among the tokens. The self-attention and feed-forward operations are iteratively performed through multiple layers of self-attention and feedforward layers, thereby generating an output based on the context of the input tokens. One forward pass for an input token to be processed through the multiple layers to generate an output in a Transformer architecture often entail hundreds of teraflops (trillions of floating-point operations) of computation.

For example, the Transformer-based architecture may process an input sequence of tokens (e.g., letters, symbols, numbers, signs, words, etc.) using its encoder-decoder architecture (for tasks such as machine translation, etc.) or just the encoder (for classification tasks) or decoder (for generation-only tasks). First, the input sequence may be tokenized and converted into embeddings, which are dense numerical representations, e.g., vectors of values. Positional encodings, such as fixed sinusoidal encodings, learnable embeddings, relative or rotary positional encodings are used to provide information about the order of tokens.

The Transformer encoder, usually consisting of multiple layers, each of which may processes the input using a multi-head self-attention mechanism to capture relationships between tokens and a feed-forward network to transform the information, resulting in encoded representations of the input sequence of tokens.

For example, the multi-head self-attention mechanism at each Transformer layer within the Transformer encoder of an LLM may project input embeddings at the layer into three different embedding spaces using weight matrices, referred to as Query (Q) representing what a token wants to attend to, Key (K) representing what this token offers as information and Value (V) representing the actual information carried by the token. The Q K, V matrices contain tunable weights of ANN 600 that are updated during training. Then, the attention mechanism computes attention scores between all tokens in the input sequence using the Q K and V matrices. The resulting attention scores are then used to generate encoded representations of the input sequence of tokens.

Similarly, the Transformer decoder may comprise a symmetric structure with the encoder, consisting of multiple layers, each of which may comprise a multi-head self-attention mechanism. The decoder may start with a special start token and use the multi-head self-attention mechanism, augmented with encoder-decoder attention to focus on relevant parts of the decoder input. The decoder may generate output tokens one by one, with each step using the previously generated tokens as part of the input and updated attention weights. Finally, the decoder may comprise a linear layer and softmax function predict probabilities for the next token in the sequence, selecting the most likely one to continue the output. This process repeats until a special end token is generated or a length limit is reached.

The generated sequence of tokens may jointly represent an output. For example, a Transformer-based LLM (such as LLM 110a-d) may receive a natural language input (such as a question) and generate a natural language output (such as an answer to the question). In one embodiment, the AI chat agent module 430 and/or its submodules 431-433 may employ a Transformer encoder-decoder and/or decoder-only structure.

In one embodiment, the AI chat agent module 430 and its submodules 431-433 may be implemented by hardware, software and/or a combination thereof. For example, the AI chat agent module 430 and its submodules 431-433 may comprise a specific neural network structure implemented and run on various hardware platforms 560, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 560 used to implement the neural network structure is specifically configured based on factors such as the complexity of the neural network, the scale of the tasks (e.g., training time, input data scale, size of training dataset, etc.), and the desired performance.

In another embodiment, some or all of layers 441, 442, 443 and/or neurons 442, 445, 446, and operations there between such as activations 461, 462, and/or the like, of the AI chat agent module 430 and its submodules 431-433 may be realized via one or more ASICs. For example, each neuron 442, 445 and 446 may be a hardware ASIC comprising a register, a microprocessor, and/or an input/output interface. For another example, operations among the neurons and layers may be implemented through an ASIC TPU. For yet another example, some operations among the neurons and layers such as a softmax operation, an activation function (such as a rectified linear unit (ReLU), sigmoid linear unit (SiLU), and/or the like) may be implemented by one or more ASICs.

In one embodiment, the neural network based AI chat agent module 230 and one or more of its submodules 431-433 may be trained by iteratively updating the underlying parameters (e.g., weights 551, 552, etc., bias parameters and/or coefficients in the activation functions 561, 562 associated with neurons) of the neural network based on the loss. For example, during forward propagation, the training data such as a training question are fed into the neural network. The data flows through the network's layers 541, 542, with each layer performing computations based on its weights, biases, and activation functions until the output layer 543 produces the network's output 550. In some embodiments, output layer 543 produces an intermediate output on which the network's output 550 is based.

The output generated by the output layer 543 is compared to the expected output (e.g., a “ground-truth” such as the corresponding answer to a training question) from the training data, to compute a loss function that measures the discrepancy between the predicted output and the expected output. For example, the loss function may be cross entropy, MMSE, and/or the like. Given the loss, the negative gradient of the loss function is computed with respect to each weight of each layer individually. Such negative gradient is computed one layer at a time, iteratively backward from the last layer 543 to the input layer 541 of the neural network. These gradients quantify the sensitivity of the network's output to changes in the parameters. The chain rule of calculus is applied to efficiently calculate these gradients by propagating the gradients backward from the output layer 543 to the input layer 541.

In one embodiment, the neural network based AI chat agent module 430 and one or more of its submodules 431-433 may be trained using policy gradient methods, also referred to as “reinforcement learning” methods. For example, instead of computing a loss based on a training output generated via a forward propagation of training data, the “policy” of the neural network model, which is a mapping from an input of the current states or observations of an environment the neural network model is operated at, to an output of action. Specifically, at each time step, a reward is allocated to an output of action generated by the neural network model. The gradients of the expected cumulative reward with respect to the neural network parameters are estimated based on the output of action, the current states of observations of the environment, and/or the like. These gradients guide the update of the policy parameters using gradient descent methods like stochastic gradient descent (SGD) or Adam. In this way, as the “policy” parameters of the neural network model may be iteratively updated while generating an output action as time progresses, the boundaries between training and inference are often less distinct compared to supervised learning-in other words, backward propagation and forward propagation may occur for both “training” and “inference” stages of the neural network mode.

In one embodiment, AI chat agent module 430 and its submodules 431-433 may be housed at a centralized server (e.g., computing device 500) or one or more distributed servers. For example, one or more of AI chat agent module 430 and its submodules 431-433 may be housed at external server(s). The different modules may be communicatively coupled by building one or more connections through application programming interfaces (APIs) for each respective module. Additional network environment for the distributed servers hosting different modules and/or submodules may be discussed in FIG. 4.

During a backward pass, parameters of the neural network are updated backwardly from the last layer to the input layer (backpropagating) based on the computed negative gradient using an optimization algorithm to minimize the loss. The backpropagation from the last layer 543 to the input layer 541 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as machine translation, document summarization, question answering, and/or the like.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

In some implementations, to improve the computational efficiency of training a neural network model, “training” a neural network model such as an LLM may sometimes be carried out by updating the input prompt, e.g., the instruction to teach an LLM how to perform a certain task. For example, while the parameters of the LLM may be frozen, a set of tunable prompt parameters and/or embeddings that are usually appended to an input to the LLM may be updated based on a training loss during a backward pass. For another example, instead of tuning any parameter during a backward pass, input prompts, instructions, or input formats may be updated to influence their output or behavior. Such prompt designs may range from simple keyword prompts to more sophisticated templates or examples tailored to specific tasks or domains.

In general, the training and/or finetuning of an LLM can be computationally extensive. For example, GPT-3 has 175 billion parameters, and a single forward pass using an input of a short sequence can involve hundreds of teraflops (trillions of floating-point operations) of computation. Training such a model requires immense computational resources, including powerful GPUs or TPUs and significant memory capacity. Additionally, during training, multiple forward and backward passes through the network are performed for each batch of data (e.g., thousands of training samples), further adding to the computational load.

In general, the training process transforms the neural network into an “updated” trained neural network with updated parameters such as weights, activation functions, and biases. The trained neural network thus improves neural network technology in AI chatbots.

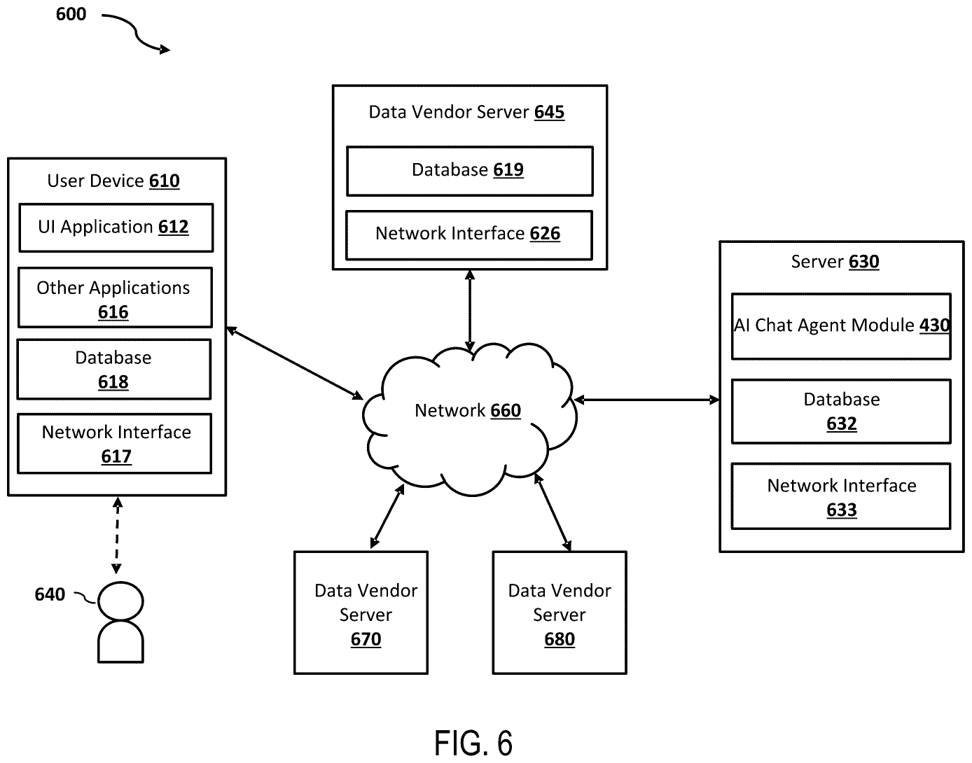

FIG. 6 is a simplified block diagram of a networked system 600 suitable for implementing the RAG LLM framework described in FIGS. 1-5 and other embodiments described herein. In one embodiment, system 600 includes the user device 610 which may be operated by user 640, data vendor servers 645, 670 and 680, server 630, and other forms of devices, servers, and/or software components that operate to perform various methodologies in accordance with the described embodiments. Exemplary devices and servers may include device, stand-alone, and enterprise-class servers which may be similar to the computing device 400 described in FIG. 4, operating an OS such as a MICROSOFT® OS, a UNIX® OS, a LINUX® OS, or other suitable device and/or server-based OS. It can be appreciated that the devices and/or servers illustrated in FIG. 6 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 610, data vendor servers 645, 670 and 680, and the server 630 may communicate with each other over a network 660. User device 610 may be utilized by a user 640 (e.g., a driver, a system admin, etc.) to access the various features available for user device 610, which may include processes and/or applications associated with the server 630 to receive an output data anomaly report.

User device 610, data vendor server 645, and the server 630 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 600, and/or accessible over network 660.

User device 610 may be implemented as a communication device that may utilize appropriate hardware and software configured for wired and/or wireless communication with data vendor server 645 and/or the server 630. For example, in one embodiment, user device 610 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 610 of FIG. 6 contains a user interface (UI) application 612, and/or other applications 616, which may correspond to executable processes, procedures, and/or applications with associated hardware. For example, the user device 610 may receive a message indicating a response from the server 630 and display the message via the UI application 612. In other embodiments, user device 610 may include additional or different modules having specialized hardware and/or software as required.

In one embodiment, UI application 612 may communicatively and interactively generate a UI for an AI agent implemented through the AI chat agent module 230 (e.g., an LLM agent) at server 630. In at least one embodiment, a user operating user device 610 may enter a user utterance, e.g., via text or audio input, such as a question, uploading a document, and/or the like via the UI application 612. Such user utterance may be sent to server 630, at which AI chat agent module 230 may generate a response via the process described in FIGS. 1-3. The AI chat agent module 230 may thus cause a display of a conversation session at UI application 612 and interactively update the display in real time with the user utterance.

In various embodiments, user device 610 includes other applications 616 as may be desired in particular embodiments to provide features to user device 610. For example, other applications 616 may include security applications for implementing client-side security features, programmatic client applications for interfacing with appropriate application programming interfaces (APIs) over network 660, or other types of applications. Other applications 616 may also include communication applications, such as email, texting, voice, social networking, and IM applications that allow a user to send and receive emails, calls, texts, and other notifications through network 660. For example, the other application 616 may be an email or instant messaging application that receives a prediction result message from the server 630. Other applications 616 may include device interfaces and other display modules that may receive input and/or output information. For example, other applications 616 may contain software programs for asset management, executable by a processor, including a graphical user interface (GUI) configured to provide an interface to the user 640 to view a response.

User device 610 may further include database 618 stored in a transitory and/or non-transitory memory of user device 610, which may store various applications and data and be utilized during execution of various modules of user device 610. Database 618 may store user profile relating to the user 640, predictions previously viewed or saved by the user 640, historical data received from the server 630, and/or the like. In some embodiments, database 618 may be local to user device 610. However, in other embodiments, database 618 may be external to user device 610 and accessible by user device 610, including cloud storage systems and/or databases that are accessible over network 660.

User device 610 includes at least one network interface component 617 adapted to communicate with data vendor server 645 and/or the server 630. In various embodiments, network interface component 617 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 645 may correspond to a server that hosts database 619 to provide training datasets to the server 630. The database 619 may be implemented by one or more relational database, distributed databases, cloud databases, and/or the like.

The data vendor server 645 includes at least one network interface component 626 adapted to communicate with user device 610 and/or the server 630. In various embodiments, network interface component 626 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 645 may send asset information from the database 619, via the network interface 626, to the server 630.

The server 630 may be housed with the AI chat agent module 430 and its submodules described in FIG. 4. In some implementations, AI chat agent module 430 may receive data from database 619 at the data vendor server 645 via the network 660 to generate a response. The generated response may also be sent to the user device 610 for review by the user 640 via the network 660.

The database 632 may be stored in a transitory and/or non-transitory memory of the server 630. In one implementation, the database 632 may store data obtained from the data vendor server 645. In one implementation, the database 632 may store parameters of the AI chat agent module 230. In one implementation, the database 632 may store previously generated responses, and the corresponding input feature vectors.

In some embodiments, database 632 may be local to the server 630. However, in other embodiments, database 632 may be external to the server 630 and accessible by the server 630, including cloud storage systems and/or databases that are accessible over network 660.

The server 630 includes at least one network interface component 633 adapted to communicate with user device 610 and/or data vendor servers 645, 670 or 680 over network 660. In various embodiments, network interface component 633 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 660 may be implemented as a single network or a combination of multiple networks. For example, in various embodiments, network 660 may include the Internet or one or more intranets, landline networks, wireless networks, and/or other appropriate types of networks. Thus, network 660 may correspond to small scale communication networks, such as a private or local area network, or a larger scale network, such as a wide area network or the Internet, accessible by the various components of system 600.

### Work Flows

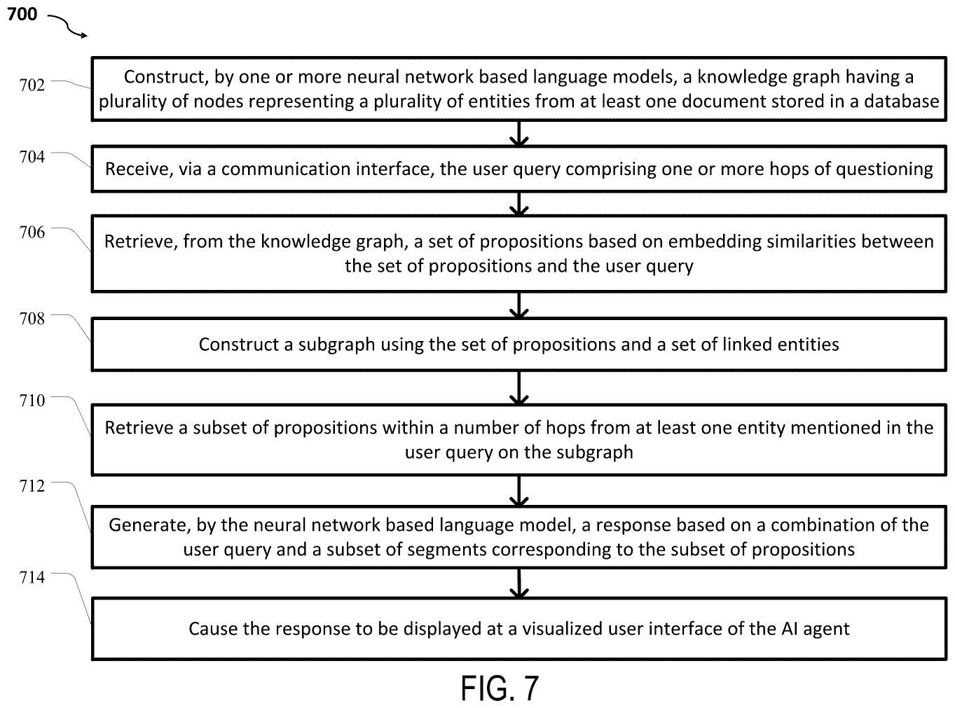

FIG. 7 is an example logic flow diagram illustrating a method of building an artificial intelligence (AI) conversation agent using a knowledge graph based on the framework shown in FIGS. 1-6, according to some embodiments described herein. One or more of the processes of method 700 may be implemented, at least in part, in the form of executable code stored on non-transitory, tangible, machine-readable media that when run by one or more processors may cause the one or more processors to perform one or more of the processes. In some embodiments, method 700 corresponds to the operation of the AI chat agent module 430 (e.g., FIGS. 4-6) that performs training and building an artificial intelligence (AI) conversation agent.

As illustrated, the method 700 includes a number of enumerated steps, but aspects of the method 700 may include additional steps before, after, and in between the enumerated steps. In some aspects, one or more of the enumerated steps may be omitted or performed in a different order.

At step 702, one or more neural network based language models (e.g., LLMs 110a-110d in FIG. 2) may construct a knowledge graph (e.g., 210 in FIG. 2) having a plurality of nodes representing a plurality of entities from at least one document (e.g., 202 in FIG. 2) stored in a database. For example, the plurality of entities may be extracted from a decontextualized version (e.g., 206 in FIG. 2) of the at least one document in which the plurality of entities take informative forms.

At step 704, a user query (e.g., 302 in FIG. 3) comprising one or more hops of questioning may be received via a communication interface (e.g., 415 in FIG. 4).

At step 706, a set of propositions (e.g., 304 in FIG. 3) may be retrieved from the knowledge graph based on embedding similarities between the set of propositions and the user query

At step 708, a subgraph (e.g., 306 in FIG. 3) may be constructed using the set of propositions and a set of linked entities.

At step 710, a subset of propositions (e.g., 308 in FIG. 3) may be selected within a number of hops from at least one entity mentioned in the user query on the subgraph. For example, the subgraph may be searched based on a traversal starting from the at least one entity mentioned in the user query. The subset of propositions may be selected within the number of hops on the subgraph during the traversal. The subset of propositions may also be re-ranked by a neural network language model.

At step 712, the neural network based language model (e.g., LLM 110 in FIG. 1) may generate a response based on a combination of the user query and a subset of segments corresponding to the subset of propositions (e.g., 310 in FIG. 3).

At step 714, the response may be displayed at a visualized user interface of the AI agent.

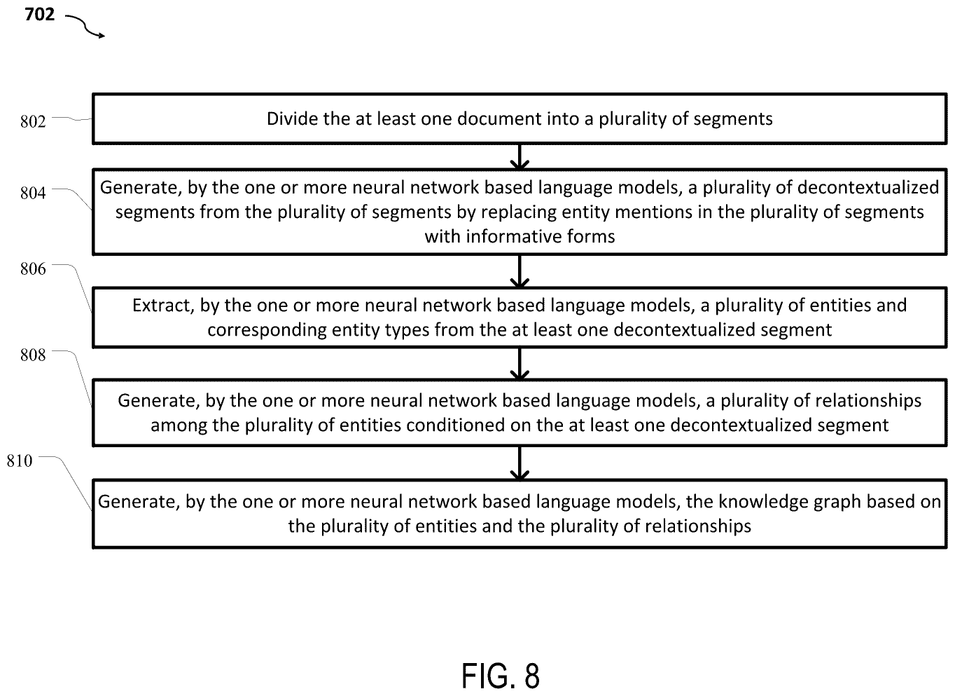

FIG. 8 is an example logic flow diagram illustrating a method of constructing a proposition-entity knowledge graph of step 702 in FIG. 7, according to some embodiments described herein. One or more of the processes of method 800 may be implemented, at least in part, in the form of executable code stored on non-transitory, tangible, machine-readable media that when run by one or more processors may cause the one or more processors to perform one or more of the processes. In some embodiments, method 700 corresponds to the operation of the AI chat agent module 430 (e.g., FIGS. 4-6) that performs training and building an artificial intelligence (AI) conversation agent.

As illustrated, the method 800 includes a number of enumerated steps, but aspects of the method 700 may include additional steps before, after, and in between the enumerated steps. In some aspects, one or more of the enumerated steps may be omitted or performed in a different order.

At step 802, the at least one document (e.g., 202 in FIG. 2) may be divided into a plurality of segments (e.g., 204 in FIG. 2).

At step 804, the one or more neural network based language models may generate a plurality of decontextualized segments (e.g., 206 in FIG. 2) from the plurality of segments by replacing entity mentions in the plurality of segments with informative forms. For example, at least one of the plurality of decontextualized segments is generated, by the one or more neural network based language models, based on previous mentions of the entity mentions in one or more preceding segments preceding at least one segment.

At step 806, the one or more neural network based language models may extract a plurality of entities and corresponding entity types (e.g., 208 in FIG. 2) from the at least one decontextualized segment.

At step 808, the one or more neural network based language models may generate a plurality of relationships among the plurality of entities conditioned on the at least one decontextualized segment. For example, each of the plurality of relationships comprise a source entity, a target entity and a proposition describing a sematic relation between the source entity and the target entity.

At step 810, the one or more neural network based language models may generate the knowledge graph (e.g., 210 in FIG. 2) based on the plurality of entities and the plurality of relationships. For example, the knowledge graph comprises a first node representing a first entity from the plurality of entities and a second node representing a first proposition from the plurality of relationships, which is associated with the first entity. For example, the at least one document (e.g., 202 in FIG. 2) and the knowledge graph (e.g., 210 in FIG. 2) form a training pair. A first neural network based language model (e.g., LLM 110d in FIG. 2) may be trained using the at lease one document as a training input and the knowledge graph as a ground truth. The first neural network based language model has a smaller size compared to the one or more neural network based language models (e.g., LLM 110a-c that are used to construct the knowledge graph).

In some embodiments, methods 700 is applicable in a variety of applications. For example, the query 302 received may relate to a diagnostic request in view of a medical record in a healthcare system, a curriculum designing request in an online education system, a code generation request in a software development system, a writing and/or editing request in a content generation system, an IT diagnostic request in an IT customer service support system, a navigation request in a robotic and autonomous system, and/or the like. By performing method 700, the neural network based artificial agent may improve technology in the respective technical field in healthcare and diagnostics, education and personalized learning, software development and code assistance, content creation, autonomous system (such as autonomous driving, etc.), and/or the like.

For example, when the query 302 includes a query to identify an information technology (IT) anomaly relating to a usage of an IT component such as a network gateway, a router, an online printer, and/or the like, by performing method 700 at an environment of a local area network (LAN), the neural network based artificial agent may receive an observation from the environment at which the next-step action is executed, and determine that the observation representing an information technology anomaly (e.g., a router failure, an unauthorized access attempt, a domain name system anomaly, and/or the like). In some implementations, the neural network based artificial agent may cause an alert relating to the information technology anomaly to be displayed at a visualized user interface. In this way, IT anomalies may be detected and alerted using the neural network based artificial agent in an efficient manner so as to improve network support technology.

In another example, the query is related to identifying specific types of objects in an image. By allowing for the automatic generation of a visual program that can accurately answer a visual question, this allows for flexibility in the system where a user may adjust what exactly is being looked for without requiring the user to be able to figure out how to code the program themselves. For example, a video monitoring system equipped with a system as described herein may monitor the video feed of a doorbell camera at a front door of a home. The user may specify that they want to be alerted if a package of a certain size is left on their doorstep. The query (either generated based on a user input or directly entered by a user) for example may be “is there a package larger than the stool” referencing a stool also in the image for comparison. Later, the user may desire to change the query to only alert if there is more than one package, with a query such as “is there more than one package on the doorstep?” Since the system improves generated programs via the automatically generated unit tests and other functions described herein, the generated program as a result of the query is more likely to not only provide an accurate result, but do so for the correct reasons, increasing the odds of the program generating the correct output for different inputs (e.g., different size packages in the image). The video monitoring system described here is exemplary, and applications of automatically generating visual programs may be applied in a number of similar and dissimilar ways.

### Example Data Experiments

In one embodiment, LLM 110a-110c employed in KG synthesis pipeline 200 in FIG. 2 may comprise Llama-3.1-70B-Instruct to synthesizing KGs from 100K documents from BAAI/IndustryCorpus2 for synthesizing KGs. An equal number of documents may be sampled from each of the following industry categories: politics, news, medicine, literature, finance, film & TV, computer science, automotive, technology, and education. A SentenceSplitter from the Llama-Index framework may split documents into chunks (e.g., 204 in FIG. 2), setting the chunk size to 256 tokens and chunk overlap to 0 tokens. A filtering criterion based on the ROUGE-1 F1 score setting a threshold of 0.70 to minimize the risk of hallucinations from decontextualization. In this way, KG synthesis may use VLLM on NVIDIA A-100 GPUS.

In one embodiment, the Transformers Python library may be used to train this distilled model (e.g., LLM 110d in FIG. 2) on NVIDIA A-100 GPUs. A learning rate of 5e-5, a batch size of 32, and train for one epoch may be adopted. The Meta-Llama-3-8B-Instruct model3 (AI@Meta, 2024) may be trained on 30K synthesized documents to directly generate corresponding KGs for entire input document. KGs extracted by the pipeline 200 (referred to as “Distill-SynthKG-8b Llama-3 model”) may be evaluated on KG coverage, text chunk retrieval and QA tasks using 3 multi-hop reasoning datasets: MuSiQue, 2WikiMultiHopQA (2wiki) and HotpotQA. For KG coverage evaluation, proxy ground-truth triplets are generated using the AzureOpenAl and GPT-4o models.

Baselines for comparison include KGs extracted by two baseline models: Llama-3-8b and Llama-3-70b5. For the retrieval and multihop QA tasks, performance of the most widely used dense vector retrieval method, as well as a dense retriever combined with an LLM-based re-ranking approach. Lastly, for the multihop QA task, results for a non-RAG system where the LLM utilizes its internal parametric knowledge to answer questions are also compared.

In one embodiment, for graph+LLM method (e.g., 300 in FIG. 3), the proposition-entity graph retriever retrieves the top 10 relevant chunks and 2-hop paths from the KG that include the question entity to generate the final answer.

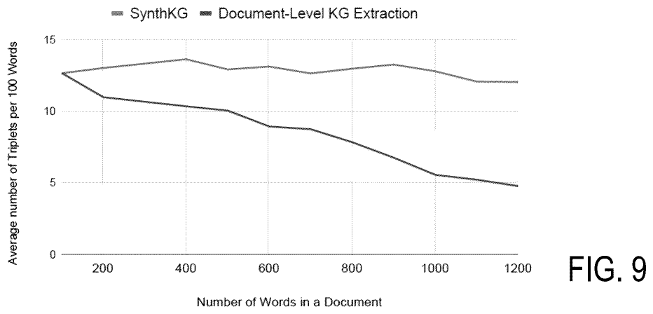

FIG. 9 compares the number of triplets generated per 100 words in documents of varying lengths using SynthKG versus a single-step LLM prompting approach. The analysis is conducted on a subset of 1,000 documents used for training Distill-SynthKG model. It is observed that for the single-step prompting approach, the ratio of extracted relations decreases as document length increases, with the triplet density dropping by approximately 60% from 100-word documents to those of 1200 words. In contrast, for SynthKG, the density remains almost constant throughout, demonstrating its effectiveness in maintaining triplet generation across documents of varying lengths.

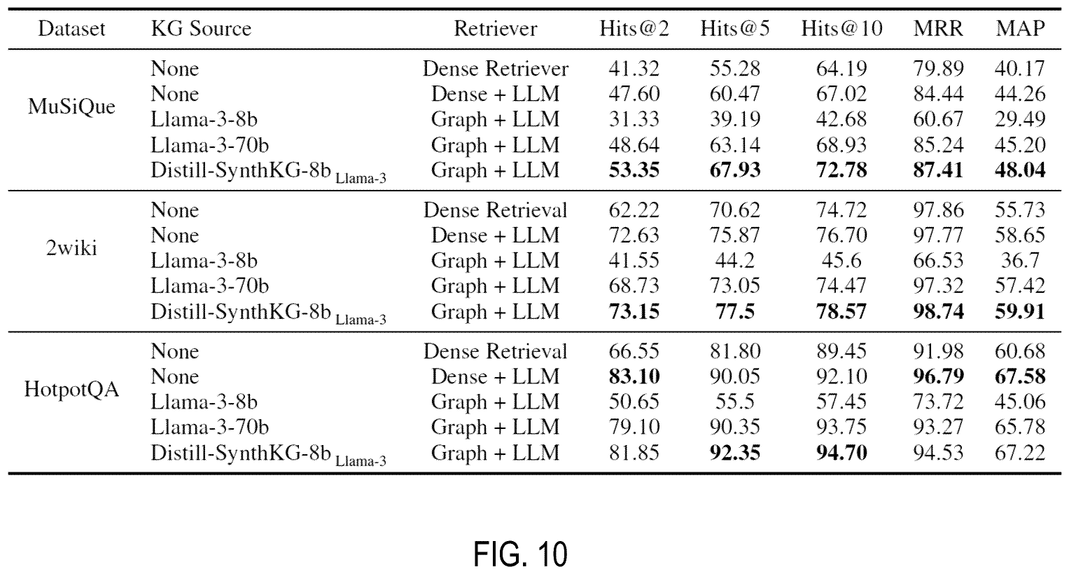

FIG. 10 shows the retrieval results: the higher KG coverage of the Distill-SynthKG-8b Llama-3 model leads to consistently superior retrieval performance across all datasets and metrics, outperforming both the unfinetuned 8b-Instruct model of the same size and the much larger 70b-Instruct model. Specifically, the graph+LLM retriever using the KGs generated by Distill-SynthKG-8b Llama-3 model achieves an average absolute improvement of 28.27 in hits@2 compared to the unfinetuned Llama-3-8b model and 3.96 in hits@2 over the larger Llama-3-70b model. Additionally, the graph+LLM retriever with Distill-SynthKG-8b Llama-3 KG model delivers an average improvement of 12.75 in hits@2 over standard dense retrieval and 1.67 in hits@2 over the dense retriever with an LLM-based reranker.

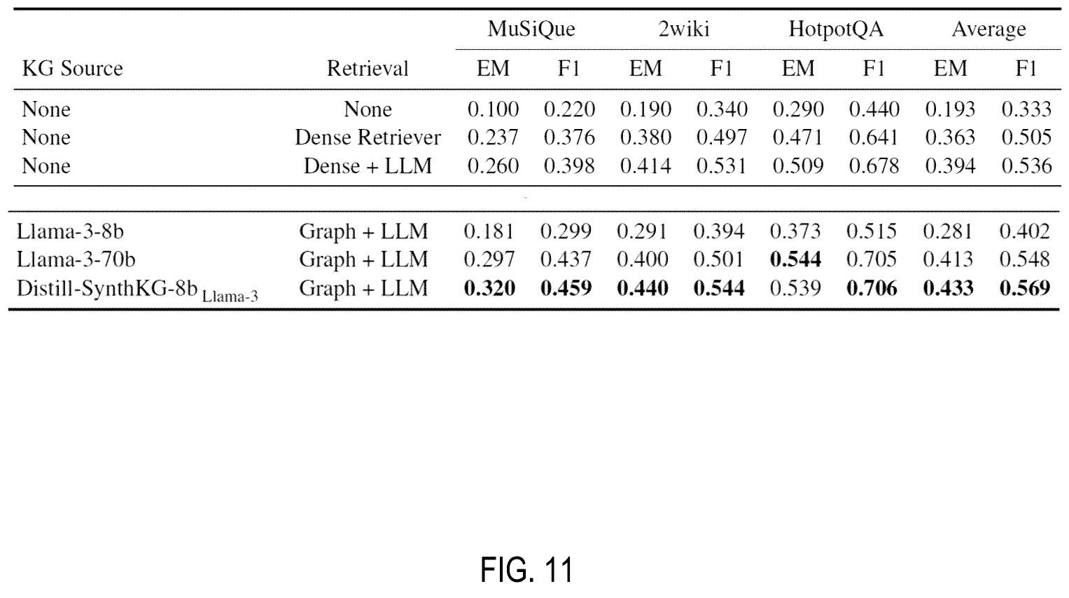

FIG. 11 shows the results of the multi-hop QA task, evaluating the general applicability of the KGs generated by Distill-SynthKG-8b Llama-3 model across different retrieval and QA frameworks. A good model, along with its extracted KGs, should ideally demonstrate robustness across various retrieval and question-answering methodologies. The results indicate that under three distinct QA frameworks (Graph+LLM), Distill-SynthKG-8b Llama-3 model's generated KGs consistently outperform its unfinetuned 8B counterpart as well as the larger 70B model. In the Graph+LLM framework, the distilled model achieves the highest gain (as reflected in the bottom row in bold), with a +15.2% absolute increase in EM accuracy over the Llama-3-8b model, resulting in the best overall performance. Additionally, both Distill-SynthKG-8b Llama-3 model and the Llama-3-70b model with the Graph+LLM retriever outperform the dense retriever as well as the dense retriever with LLM reranker, highlighting the importance of using our entity-proposition graph retriever in conjunction with the KG to achieve optimal results.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is;:

1. A method of generating a response to a user by an artificial intelligence (AI) chat agent, the method comprising:
constructing, by one or more neural network based language models, a knowledge graph having a plurality of nodes representing a plurality of entities from at least one document stored in a database, wherein the constructing comprises:
extracting the plurality of entities from a decontextualized version of the at least one document in which the plurality of entities take informative forms;
receiving, via a communication interface, the user query comprising one or more hops of questioning;
retrieving, from the knowledge graph, a set of propositions based on embedding similarities between the set of propositions and the user query;
constructing a subgraph using the set of propositions and a set of linked entities;
retrieving a subset of propositions within a number of hops from at least one entity mentioned in the user query on the subgraph;
generating, by the neural network based language model, a response based on a combination of the user query and a subset of segments corresponding to the subset of propositions; and
causing the response to be displayed at a visualized user interface of the AI agent.

2. The method of claim 1, wherein the constructing the knowledge graph further comprises:
dividing the at least one document into a plurality of segments; and
generating, by the one or more neural network based language models, a plurality of decontextualized segments from the plurality of segments by replacing entity mentions in the plurality of segments with informative forms.

3. The method of claim 2, wherein at least one of the plurality of decontextualized segments is generated, by the one or more neural network based language models, based on previous mentions of the entity mentions in one or more preceding segments preceding at least one segment.

4. The method of claim 3, further comprising:
extracting, by the one or more neural network based language models, a plurality of entities and corresponding entity types from the at least one decontextualized segment; and
generating, by the one or more neural network based language models, a plurality of relationships among the plurality of entities conditioned on the at least one decontextualized segment,
wherein each of the plurality of relationships comprise a source entity, a target entity and a proposition describing a sematic relation between the source entity and the target entity.

5. The method of claim 3, further comprising:
generating, by the one or more neural network based language models, the knowledge graph based on the plurality of entities and the plurality of relationships,
wherein the knowledge graph comprises a first node representing a first entity from the plurality of entities and a second node representing a first proposition from the plurality of relationships, which is associated with the first entity.

6. The method of claim 1, wherein the retrieving the subset of propositions comprises:
searching the subgraph based on a traversal starting from the at least one entity mentioned in the user query; and
selecting and ranking, by at least one of the one or more neural network based language models the subset of propositions within the number of hops on the subgraph during the traversal.

7. The method of claim 1, wherein the at least one document and the knowledge graph form a training pair, and the method further comprises:
training a first neural network based language model using the at lease one document as a training input and the knowledge graph as a ground truth,
wherein the first neural network based language model has a smaller size compared to the one or more neural network based language models.

8. The method of claim 1, wherein the user query comprises a task query to identify a network issue within an information technology infrastructure, and wherein the response comprises information of an identified network anomaly associated with a network address, and the method comprises:
sending an alert to be displayed at a visualized user interface of the AI agent; and
isolating and/or discarding one or more data packets originated from the network address.

9. A system of generating a response to a user by an artificial intelligence (AI) chat agent, the system comprising:
a communication interface receiving a user query comprising one or more hops of questioning;
a memory storing s database of documents and a plurality of processor-readable instructions; and
one or more processors executing the plurality of processor-readable instructions to perform operations comprising:
constructing, by one or more neural network based language models, a knowledge graph having a plurality of nodes representing a plurality of entities from at least one document stored in the database, wherein the constructing comprises:
extracting the plurality of entities from a decontextualized version of the at least one document in which the plurality of entities take informative forms;
retrieving, from the knowledge graph, a set of propositions based on embedding similarities between the set of propositions and the user query;
constructing a subgraph using the set of propositions and a set of linked entities;
retrieving a subset of propositions within a number of hops from at least one entity mentioned in the user query on the subgraph;
generating, by the neural network based language model, a response based on a combination of the user query and a subset of segments corresponding to the subset of propositions; and
causing the response to be displayed at a visualized user interface of the AI agent.

10. The system of claim 9, wherein the operation of constructing the knowledge graph further comprises:
dividing the at least one document into a plurality of segments; and
generating, by the one or more neural network based language models, a plurality of decontextualized segments from the plurality of segments by replacing entity mentions in the plurality of segments with informative forms.

11. The system of claim 10, wherein at least one of the plurality of decontextualized segments is generated, by the one or more neural network based language models, based on previous mentions of the entity mentions in one or more preceding segments preceding at least one segment.

12. The system of claim 11, wherein the operations further comprise:
extracting, by the one or more neural network based language models, a plurality of entities and corresponding entity types from the at least one decontextualized segment; and
generating, by the one or more neural network based language models, a plurality of relationships among the plurality of entities conditioned on the at least one decontextualized segment,
wherein each of the plurality of relationships comprise a source entity, a target entity and a proposition describing a sematic relation between the source entity and the target entity.

13. The system of claim 11, wherein the operations further comprise:
generating, by the one or more neural network based language models, the knowledge graph based on the plurality of entities and the plurality of relationships,
wherein the knowledge graph comprises a first node representing a first entity from the plurality of entities and a second node representing a first proposition from the plurality of relationships, which is associated with the first entity.

14. The system of claim 9, wherein the operation of retrieving the subset of propositions comprises:
searching the subgraph based on a traversal starting from the at least one entity mentioned in the user query; and
selecting the subset of propositions within the number of hops on the subgraph during the traversal.

15. The system of claim 9, wherein the at least one document and the knowledge graph form a training pair, and the system further comprises:
training a first neural network based language model using the at lease one document as a training input and the knowledge graph as a ground truth,
wherein the first neural network based language model has a smaller size compared to the one or more neural network based language models.

16. A non-transitory storage medium storing a plurality of processor-readable instructions for generating a response to a user by an artificial intelligence (AI) chat agent, the processor-readable instructions executed by one or more processors to perform operations comprising:
constructing, by one or more neural network based language models, a knowledge graph having a plurality of nodes representing a plurality of entities from at least one document stored in a database, wherein the constructing comprises:
extracting the plurality of entities from a decontextualized version of the at least one document in which the plurality of entities take informative forms;
receiving, via a communication interface, the user query comprising one or more hops of questioning;
retrieving, from the knowledge graph, a set of propositions based on embedding similarities between the set of propositions and the user query;
constructing a subgraph using the set of propositions and a set of linked entities;
retrieving a subset of propositions within a number of hops from at least one entity mentioned in the user query on the subgraph;
generating, by the neural network based language model, a response based on a combination of the user query and a subset of segments corresponding to the subset of propositions; and
causing the response to be displayed at a visualized user interface of the AI agent.

17. The non-transitory storage medium of claim 16, wherein the constructing the knowledge graph further comprises:
dividing the at least one document into a plurality of segments; and
generating, by the one or more neural network based language models, a plurality of decontextualized segments from the plurality of segments by replacing entity mentions in the plurality of segments with informative forms.

18. The non-transitory storage medium of claim 17, wherein at least one of the plurality of decontextualized segments is generated, by the one or more neural network based language models, based on previous mentions of the entity mentions in one or more preceding segments preceding at least one segment.

19. The non-transitory storage medium of claim 18, wherein the operations further comprise:
extracting, by the one or more neural network based language models, a plurality of entities and corresponding entity types from the at least one decontextualized segment; and
generating, by the one or more neural network based language models, a plurality of relationships among the plurality of entities conditioned on the at least one decontextualized segment,
wherein each of the plurality of relationships comprise a source entity, a target entity and a proposition describing a sematic relation between the source entity and the target entity.

20. The non-transitory storage medium of claim 18, wherein the operations further comprise:
generating, by the one or more neural network based language models, the knowledge graph based on the plurality of entities and the plurality of relationships,
wherein the knowledge graph comprises a first node representing a first entity from the plurality of entities and a second node representing a first proposition from the plurality of relationships, which is associated with the first entity.
